(19) United States
(12) Patent Application Publication
(10) Pub. No.: US 2006/0104631 A1
(43) Pub. Date: May 18, 2006

(54) Method of taking a picture by composing images

(75) Inventors: David Ho, Taipei (TW); Ying Liu, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/111,728

(22) Filed: Apr. 22, 2005

(30) Foreign Application Priority Data
Nov. 17, 2004 (TW) 093135179

(51) Int. Cl. G03B 41/00

(52) U.S. Cl. 396/322

(57) ABSTRACT

The present invention is to provide a method of taking a picture for a camera device by composing images, wherein an image software installed in the camera device provides a plurality of frames each having a plurality of image reserved areas, comprising the steps of running the image software; selecting one of the frame by a user through the image software; enabling the camera device to capture at least one image data record; enabling the camera device to run the image software to locate each of image data records in each of the image reserved areas of the selected frame; and forming a composite picture (e.g., portrait), thus, a user can easily compose a picture prior to taking a picture of same.

### FIELD OF THE INVENTION

The present invention relates to composite images of picture taking, and more particularly to a method of taking a picture by means of an image capturing device by composing one or more subjects decorated with a frame.

### BACKGROUND OF THE INVENTION

Cellular phones are gaining popularity as technology advances. Moreover, in addition to as a convenient communication tool, newer types of cellular phone are provided with many advanced features including camera, video games, phonebook, calculator, notebook, Internet accessing, and short message sending or receiving. Such features make the cellular phone more powerful so that a user can be satisfied with such a multifunctional cellular phone.

Some types of commercially available cellular phones are equipped with camera (snapshot) feature. In operating a cellular phone, a user may select a desired frame, next, capture image data of a subject (e.g., person, pet, or the like) and locate in the selected frame. Next, compose all of the above subjects with a background to form a desired picture. Finally, record the final picture. This has completed the feature of taking a picture (snapshot) by means of a cellular phone.

Moreover, in the camera feature of a photo express machine, there is provided a frame with a number of image reserved areas. In operating the photo express machine, a selected frame can be shown on a display screen (e.g., monitor). Also, a plurality of image reserved areas and image data of a subject to be taken are shown in the selected frame. A user thus can view the position of the subject relative to the image reserved areas prior to adjusting them to an optimum one.

However, in a case of a frame having a plurality of image reserved areas of the cellular phone selected, the subject (e.g., a person) cannot see image data shown on the frame prior to taking a picture. Thus, another person who is about to take a picture of the subject has to adjust the position of the subject and others in the frame until all are suitably focused on their respective image reserved areas. In view of above, such picture taking procedure is very tedious and the taken picture may be not the desired one. Hence, a need has arisen for an improved method of taking a picture by focusing one or more subjects on a frame having a plurality of image reserved areas in order to overcome the inadequacies of the prior art.

### SUMMARY OF THE INVENTION

After considerable research and experimentation, a method of taking a picture by composing images according to the present invention has been devised so as to overcome the above drawback of the prior art.

It is an object of the present invention to provide a method of taking a picture for a camera device (e.g., a cellular phone having camera feature) by composing images, wherein an image software (e.g., camera software) installed in the camera device provides a plurality of frames each having a plurality of image reserved areas, and enables the camera device to proceed with a process comprising the steps of selecting one of the frame by a user through the image software; capturing at least one image data record by the camera device; enabling the camera device to run the image software to locate each of image data records in each of the image reserved areas of the selected frame; and forming a composite picture (e.g., portrait). By utilizing this method, a user can easily compose a picture prior to taking a picture of same.

The above and other objects, features and advantages of the present invention will become apparent from the following detailed description taken with the accompanying drawings.

### BRIEF DESCRIPTION OF THE DRAWINGS

FIG. 1 is a block diagram of a camera device according to the invention;

FIG. 2 is a front view of a composite picture formed by means of the camera device; and

FIGS. 3 and 4 are flow charts illustrating first and second preferred embodiments of method of taking a picture by composing images according to the invention respectively.

### DETAILED DESCRIPTION OF THE PREFERRED EMBODIMENTS

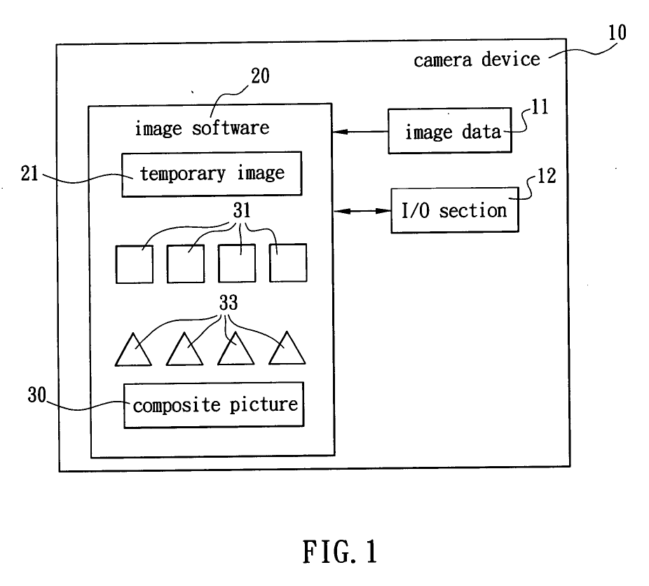

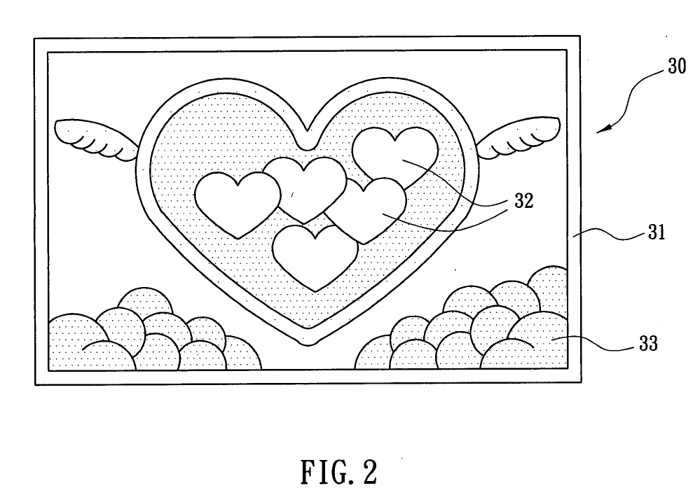

Referring to FIGS. 1 and 2, there is shown a camera device 10 employed by a method of taking a picture by composing images according to the invention. The camera device 10 is implemented as a cellular phone having camera feature, a PDA (personal digital assistant) having camera feature, a PC (personal computer) having Webcam (web camera) feature, a DC (digital camera), or a DV (digital video). An image software (e.g., camera software) 20 is installed in the camera device 10. A plurality of frames 31 are provided in the image software 20. Each frame 31 has a plurality of image reserved areas 32 each shaped as a specific one (e.g., heart, diamond, or the like).

Referring to FIGS. 1, 2, 3, and 4, in a case of the image software 20 being run, the frames 31 can be selected by a user through the image software. Also, at least one image data record is captured by the camera device 10. Thus, the camera device 10 is able to run the image software 20 to locate each image data record in each of the image reserved areas 32 of the frame 31. Finally, a composite picture 30 is formed. By configuring as above, image data can be correctly located in respective image reserved areas 32 without adjusting each position of subjects (e.g., person) by another person who is taking a picture of the subject.

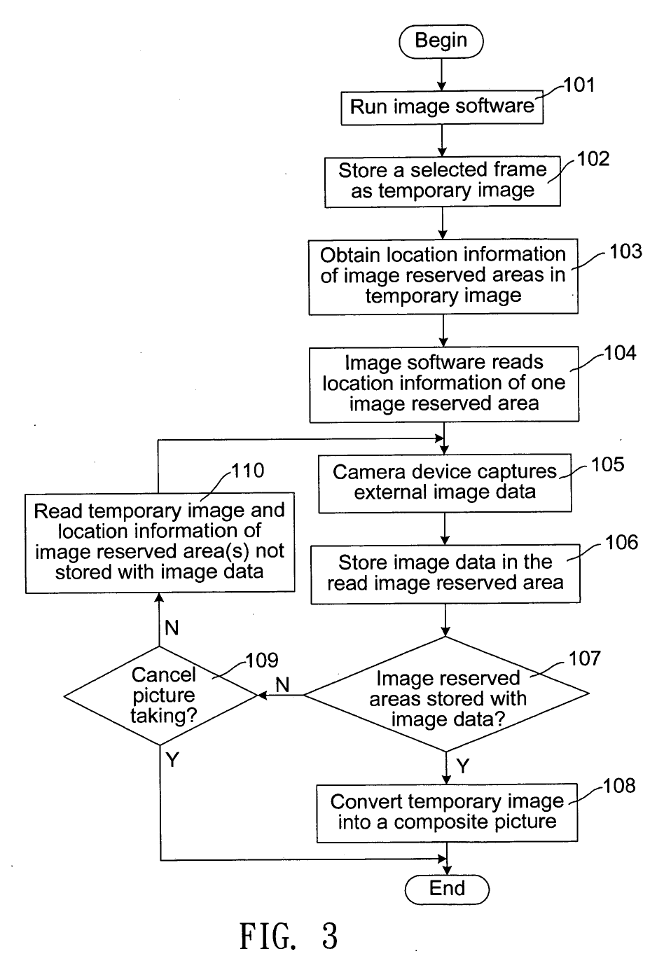

Referring to FIG. 3 in conjunction with FIGS. 1 and 2, a process of a first preferred embodiment of the invention is illustrated. In a case of the camera device 10 activated, the camera device 10 may perform the following steps to form a composite picture 30 to be taken.

Step 101, run the image software 20 to provide at least one frame 31 each having a plurality of image reserved areas 32.

Step 102, after one frame 31 of the image software 20 being selected, the image software 20 stores the selected frame 31 as a temporary image 21.

Step 103, the image software 20 analyzes the temporary image 21 to obtain location information of the image reserved areas 32 in the temporary image 21.

Step 104, the image software 20 reads location information of one of the image reserved areas 32.

Step 105, the camera device 10 captures image data 11 from external environment.

Step 106, store the image data 11 in the read image reserved area 32 for updating and rewriting the temporary image 21.

Step 107, it is determined by the image software 20 whether all of the image reserved areas 32 in the temporary image 21 are stored with image data 11. If yes, the process goes to step 108. Otherwise, the process goes to step 109.

Step 108, convert the temporary image 21 having the stored image data 11 into a composite picture 30.

Step 109, it is determined whether a user has cancelled the picture taking of the composite picture 30. If yes, the process ends accordingly. Otherwise, the process goes to step 110.

Step 110, the image software 20 reads the temporary image 21 and location information of one or more image reserved areas 32 not stored with image data 11 again prior to looping back to step 105.

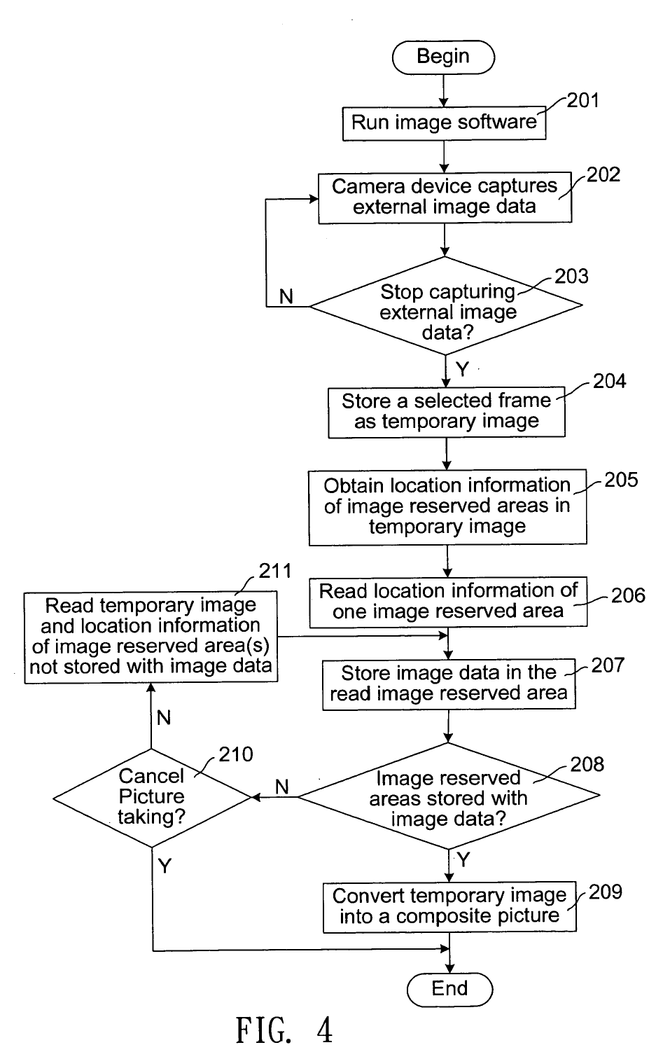

Referring to FIG. 4 in conjunction with FIGS. 1 and 2, a process of a second preferred embodiment of the invention is illustrated. In a case of the camera device 10 activated, the camera device 10 may also perform the following steps to form a composite picture 30 to be taken.

Step 201, run the image software 20 to provide at least one frame 31 each having a plurality of image reserved areas 32.

Step 202, the camera device 10 continuously captures image data 11 from external environment.

Step 203, it is determined whether the camera device 10 has stopped capturing image data 11 from the external environment. If yes, the process goes to step 204. Otherwise, the process loops back to step 202.

Step 204, after being selected one frame 31, the image software 20 stores the selected frame 31 as a temporary image 21.

Step 205, the image software 20 analyzes the temporary image 21 to obtain location information of the image reserved areas 32 in the temporary image 21.

Step 206, the image software 20 reads location information of one of the image reserved areas 32.

Step 207, store the image data 11 in the read image reserved area 32 for updating and rewriting the temporary image 21.

Step 208, it is determined by the image software 20 whether all of the image reserved areas 32 in the temporary image 21 are stored with image data 11. If yes, the process goes to step 209. Otherwise, the process jumps to step 210.

Step 209, convert the temporary image 21 having the stored image data 11 into a composite picture 30.

Step 210, it is determined whether a user has cancelled the picture taking of the composite picture 30. If yes, the process ends accordingly. Otherwise, the process goes to step 211.

Step 211, the image software 20 reads the temporary image 21 and location information of one or more image reserved areas 32 not stored with image data 11 again prior to looping back to step 207.

Referring to FIGS. 1 and 2 again, in each embodiment of the invention described above there are a plurality of backgrounds 33 (e.g., landscapes, Chinese paintings, photographs of racing car or the like) provided in the image software 20. Thus, it is also possible of running the image software 20 to select one frame 31 and composing the selected background 33 and the frame 31. A composite picture 30, formed by the method of taking a picture as a beautiful background by composing images of the invention.

Referring to FIGS. 1 and 2 again, it is also possible of storing image data in respective image reserved areas 32 of a frame 31 for forming a composite picture 30. Next, compose the composite picture 30 and a selected one of the backgrounds 33. In brief, a user can change background 33 of the composite picture 30 as desired.

Referring to FIG. 1 again, in each embodiment described above the camera device 10 comprises an I/O section 12 electrically connected to an electronic device (e.g., a PC (personal computer), a PDA (personal digital assistant), a printer, or a plotter) such that the camera device 10 is able to send a composite picture 30 to the electronic device for output. For example, screen, photograph, poster, sticker, picture on a mug, or picture on a clothes is the target of the output.

Referring to FIGS. 1 and 4 again, the camera device 10 is able to command the I/O section 12 to receive a plurality of image data records 11 from the electronic device. Next, the camera device 10 is able to capture external image data 11 and perform a series of steps as described in the above second embodiment to form a composite picture 30.

The above I/O section 12 is implemented as a hardware standard for external device connections (e.g., USB (universal serial bus) port, or IEEE 1394 (Institute of Electrical and Electronics Engineers 1394) or so-called Firewire) or a standard of for wireless network (e.g., Bluetooth, or IR (infrared)).

While the invention herein disclosed has been described by means of specific embodiments, numerous modifications and variations could be made thereto by those skilled in the art without departing from the scope and spirit of the invention set forth in the claims.

What is claimed is:

1. A method of taking a picture by composing images for a camera device, wherein an image software installed in the camera device provides a plurality of frames each having a plurality of image reserved areas, comprising the steps of:
running the image software;
selecting one of the frame through the image software;
capturing at least one image data record by the camera device;
enabling the camera device to run the image software to locate each of image data records in each of the image reserved areas of the selected frame; and
forming a composite picture.

2. The method of claim 1, wherein the camera device performs the steps of:
running the image software;
after being selected one of the frames of the image software, enabling the image software to store the selected frame as a temporary image;
enabling the image software to analyze the temporary image to obtain location information of each of the image reserved areas in the temporary image;
enabling image software to read the location information of one of the image reserved areas;
capturing image data from external environment;
storing the image data in the read image reserved area for updating and rewriting the temporary image;
enabling the image software to determine whether each of the image reserved areas in the temporary image is stored with the image data; and
if the determination that each of the image reserved areas in the temporary image is stored with the image data is positive, converting the temporary image having the stored image data into a composite picture.

3. The method of claim 2, wherein if the determination that not all of the image reserved areas in the temporary image are stored with the image data the camera device performs the steps of:
determining whether a picture of the composite picture to be taken has been cancelled;
enabling the image software to read the temporary image and the location information of one or more image reserved areas not stored yet with the image data;
looping back to the step of storing the image data in the read image reserved area for updating and rewriting the temporary image and continuing the remain processes.

4. The method of claim 1, wherein the camera device performs the steps of:
running the image software;
capturing image data from external environment;
determining that the camera device has stopped capturing image data from external environment
after one of the frames of the image software being selected, the image software storing the selected frame as a temporary image;
enabling the image software to analyze the temporary image to obtain location information of each of the image reserved areas in the temporary image;
enabling image software to read the location information of one of the image reserved areas;
storing the image data in the read image reserved area for updating and rewriting the temporary image;
enabling the image software to determine whether each of the image reserved areas in the temporary image is stored with the image data; and
if the determination that each of the image reserved areas in the temporary image is stored with the image data is positive converting the temporary image having the stored image data into a composite picture.

5. The method of claim 4, wherein if the determination that the camera device has not stopped capturing image data from external environment, the camera device loops back to the step of capturing image data from external environment, and continues the remain processes.

6. The method of claim 4, wherein if the determination that not all of the image reserved areas in the temporary image are yet stored with the image data the camera device performs the steps of:
determining whether a picture of the composite picture to be taken has been cancelled;
enabling the image software to read the temporary image and the location information of one or more image reserved areas not stored with the image data again; and
storing the image data in the read image reserved area for updating and rewriting the temporary image.
looping back to the step of enabling the image software to determine whether each of the image reserved areas in the temporary image is stored with the image data, and continuing the remain processes.

7. The method of claim 1, wherein the image software further comprises a plurality of backgrounds each adapted to select to compose with the selected frame.

8. The method of claim 1, wherein the camera device further comprises an I/O section electrically connected to an electronic device.

9. The method of claim 8, wherein the electronic device is a cellular phone having camera means.

10. The method of claim 8, wherein the I/O section is a USB port.
